(19) United States
(12) Patent Application Publication
(10) Pub. No.: US 2013/0110630 A1
(43) Pub. Date: May 2, 2013

(54) BIDDING FOR IMPRESSIONS

(71) Applicants: Saar Yahalom, Tel Aviv (IL); Dima Stopel, Herzliya (IL)

(72) Inventors: Saar Yahalom, Tel Aviv (IL); Dima Stopel, Herzliya (IL)

(73) Assignee: MICROSOFT CORPORATION, Redmond, WA (US)

(21) Appl. No.: 13/282,489

(22) Filed: Oct. 27, 2011

(51) Int. Cl. G06Q 30/02

(52) U.S. Cl. 705/14.58

(57) ABSTRACT

A method of providing impressions of a mobile ad is provided in which a vendor may bid for impressions of the ad responsive to a distribution of a number of potential consumers of a given vendor service and/or product as a function of consumer location and probability of purchasing the given service or product.

### TECHNICAL FIELD

Embodiments of the invention relate to methods and systems for providing impressions of ads on a person's mobile communication device.

### BACKGROUND

“Impressions” conventionally refer to the appearances of online image and/or text advertisements, “web ads”, on a web page accessed by a person during his or her search for desired material in the Internet. The web ads appear on web pages that the person accesses responsive to key words that the person uses to search the Internet for the desired material. Many and varied forms of web-ads, such as pop-up and video web ads, floating web ads, wall paper web ads and mobile web ads, which present SMS text or multimedia messages on mobile devices, have been developed as use of the web for advertising and marketing has undergone explosive growth.

It is noted that a mobile web ad, hereinafter also referred to as a “mobile ad”, may appear both as part of a web page or as a standalone ad on the screen of a mobile device independent of a web page. A mobile ad sent to a mobile device may also be transmitted to a person's mobile device through a mobile phone network or networks, independent of the Internet and/or browsing on the Internet.

Web ad impressions are paid for by a vendor who expects that a person using keywords that link the person to a web site having material related to a product and/or service offered by the vendor might have a heightened interest in purchasing or using the vendor's product and/or service. Generally, if the person interacts with the vendor's web ad by clicking on it, the person is linked to a vendor web site that enables the person to undertake an action, such as making a purchase or signing up for a subscription, related to the product or service.

For example, a manager of a book store dealing in art books might reasonably consider that a person searching for locations of museums might have a heightened interest in art books. The manager may therefore contact an “ad server” company that operates computer servers, conventionally referred to as “ad servers”, which store and deliver web ads to their destinations, to have web ads advertising the manager's store placed on web pages accessed by persons searching the Internet using the key-word “museums”. If a person reaches a web page with the book store's web ad and clicks on the ad, the person may be linked to a web site run by the store and purchase an art book. Hereinafter, “purchasing” “subscribing”, and performing any act, such as visiting a store, that a web ad is intended to elicit, is referred to generically as “purchasing”.

Many different methods, referred to by a plethora of acronyms, exist for charging vendors for impressions (appearances) of web ads. Among the methods are: CPT, “cost per thousand”, in which the vendor pays per thousand impressions loaded onto web pages; CPC, “cost per click”, in which the vendor pays for each time a web user clicks on the vendor's web ad and is linked to the vendor's website; and various types of CPAs, “cost per action”, in which the vendor pays only if a user completes a transaction, such as a purchase or sign-up, with the vendor via the vendor site.

Substantial effort is often invested by vendors in analyzing data that characterizes responses to web ads and in locating web pages and locations on web pages that provide advantageous returns, in clicks and/or purchase, for money invested in impressions. For a given product or service advantageous web pages and locations for impressions of web ads on a given web page are therefore typically known to vendors providing the given product or service. Ad server companies have therefore often found it advantageous to market web ad impressions using a bidding system in which vendors bid for impressions on desired web pages and/or on desired locations on web pages.

### SUMMARY

An aspect of an embodiment of the invention relates to providing a bidding system for selling impressions of mobile ads to be sent to mobile communication devices of a community of consumers responsive to their respective geographical locations and personal profiles. In an embodiment of the invention, the profiles and geographical locations are processed to generate a distribution, hereinafter a consumer distribution that gives a number of the consumers as a function of their location and probability of purchasing a given product and/or service. In accordance with the bidding system, impressions for mobile ads promoting the given product and/or service to be sent to the consumers' mobile devices are auctioned off to vendors of the given product and/or service responsive to the consumer distribution.

In an embodiment of the invention, a mobile ad server company or system, hereinafter also referred to as a “MOBAD-Com”, operates the bidding system to send mobile ads to consumers who subscribe with the MOBAD-Com to accept mobile ads for products and/or services they may be interested in purchasing. In accordance with the bidding system, the MOBAD-Com generates consumer distributions responsive to the locations and personal profiles of the subscribers. Mobile ads that are transmitted to the subscribers are provided by vendors who access the MOBAD-Com via a MOBAD-Com Internet site to place bids for impressions on the subscribers' mobile devices responsive to the consumer distributions.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical structures, elements or parts that appear in more than one figure are generally labeled with a same numeral in all the figures in which they appear. Dimensions of components and features shown in the figures are chosen for convenience and clarity of presentation and are not necessarily shown to scale.

FIG. 1 schematically shows a MOBAD-Com providing vendors and consumers with a bidding system for impressions of mobile ads to be sent to the consumers mobile devices responsive to consumer locations and profiles, in accordance with an embodiment of the invention; and

FIGS. 2A and 2B show three dimensional (3D) column charts of hypothetical consumer distributions generated by the MOBAD-Com shown in FIG. 1, in accordance with an embodiment of the invention.

### DETAILED DESCRIPTION

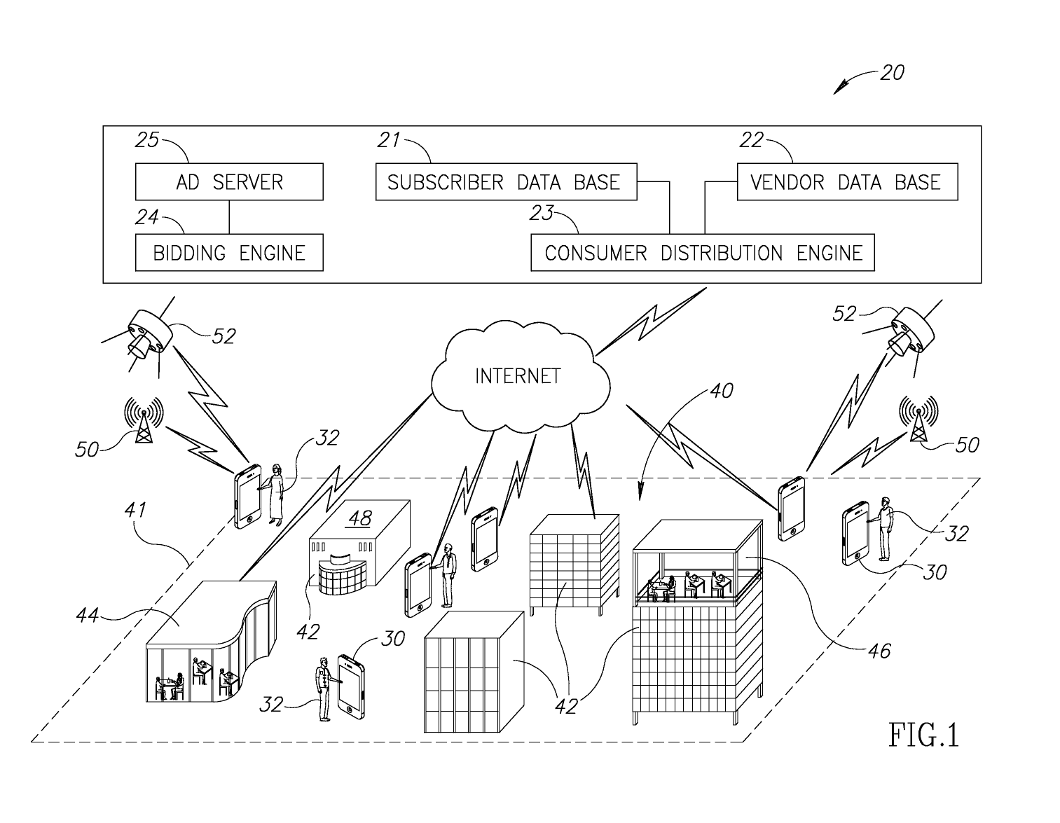

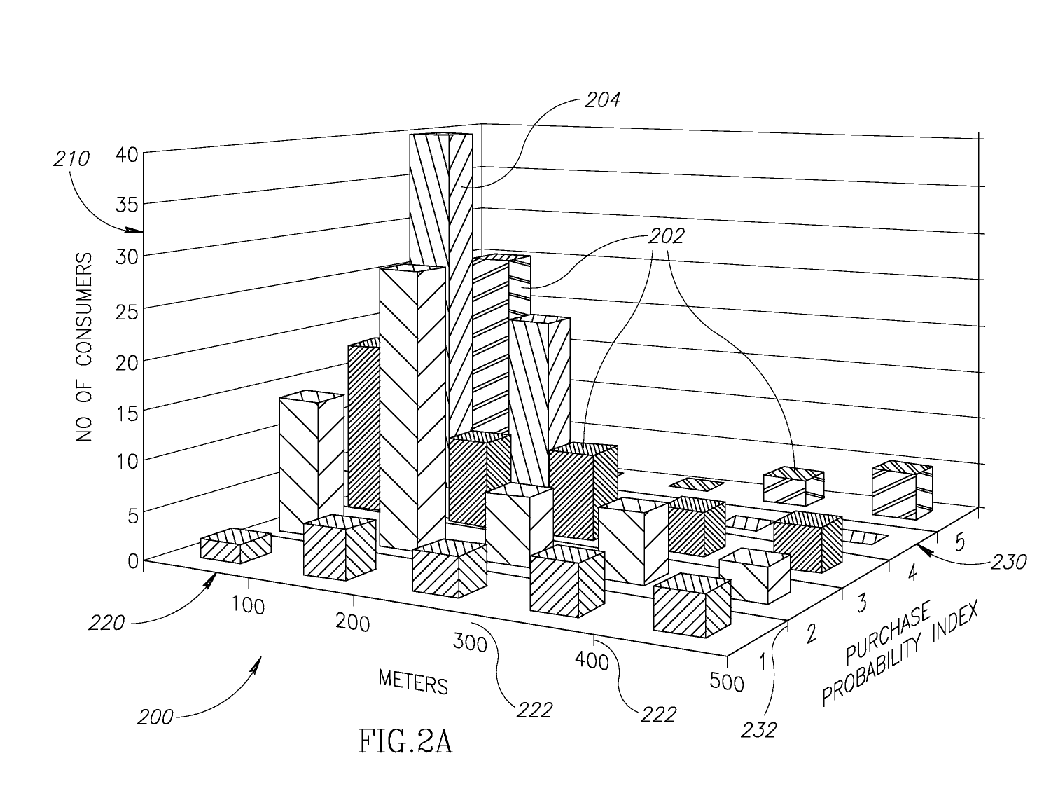

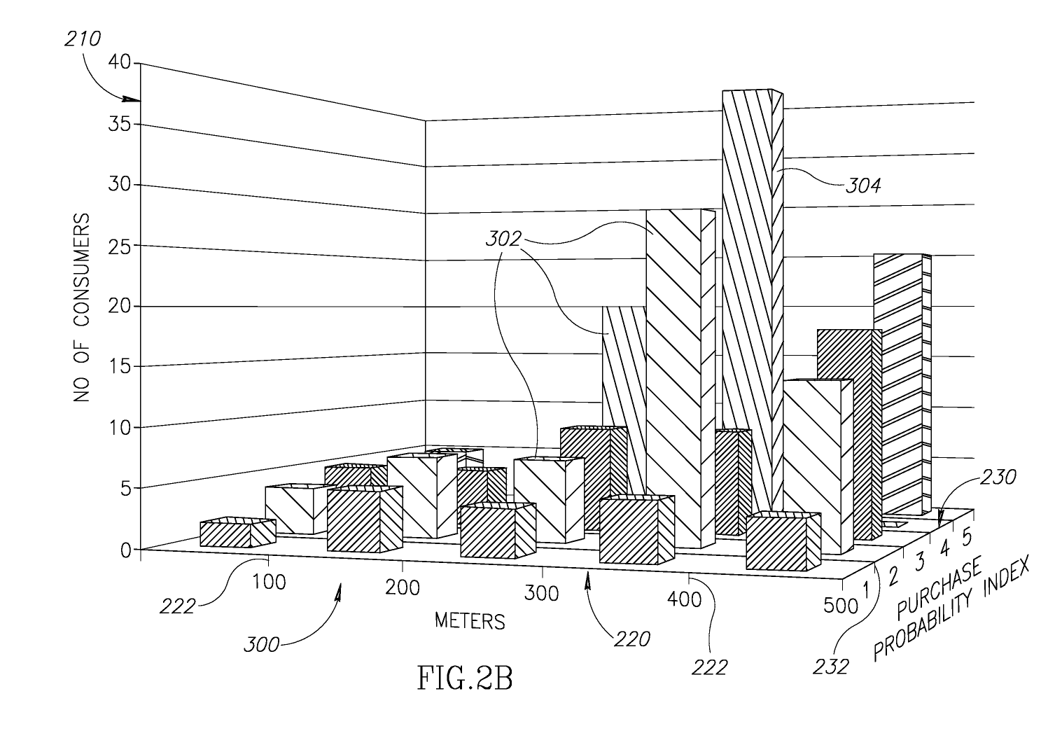

In the following detailed description, a MOBAD-Com operating a bidding system in accordance with an embodiment of the invention for auctioning impressions for vendor mobile web-ads to be placed on mobile devices of consumers subscribed to the MOBAD-Com is described with reference to FIG. 1. FIGS. 2A and 2B shows column charts of hypothetical consumer distributions generated by the MOBAD-Com responsive to locations and profiles of the subscribers. Use of the consumer distributions by the vendors and/or the MOBAD to respectively submit and/or implement bids by the vendors is discussed with reference to FIG. 1 and FIGS. 2A and 2B.

FIG. 1. Schematically shows a MOBAD-Com 20 that operates in accordance with an embodiment of the invention to place impressions of mobile ads on mobile devices 30 of consumers 32 that are subscribed with the MOBAD-Com to receive mobile ads from vendors who use the MOBAD-Com.

MOBAD-Com 20 is assumed to provide its services in an urban region 40 schematically delineated by a dashed rectangle 41. Mobile devices 30 are assumed to be smart phones and consumers 32, also referred to as subscribers 32, may use their smart phones to communicate with MOBAD-Com 20 via the Internet and/or a mobile phone network represented by base station antennas 50, which numeral 50 is also used to reference the mobile phone network. Vendors in urban region 40 who use MOBAD-Com 20 to place mobile ads with subscribers 32 are represented by buildings 42 that schematically represent the vendor businesses. Numeral 42 is used to generically reference the vendors. Vendors 42 may communicate with MOBAD-Com 20 via the Internet by accessing and interfacing with a MOBAD-Com web site (not shown) and/or through mobile phone network 50. In FIG. 1 vendors 42 are assumed by way of example, to include restaurants that are individualized by labels 44 and 46. The restaurants are located relatively far from each other in urban region 40. Urban region 40 includes a vendor 42 that is a theater, which is individualized by a label 48.

In accordance with an embodiment of the invention, MOBAD-Com 20 maintains a subscriber data base 21, a vendor data base 22, and operates a consumer distribution engine 23, a bidding engine 24, and a mobile ad server 25. Whereas in FIG. 1 all components of MOBAD-Com 20 appear housed together in a same device or venue, practice of the invention is not limited to a “centralized” MOBAD-Com in which all, or substantially all, of the MOBAD-Com components are in a single device or located at a same location. A MOBAD-Com may have a distributed configuration with components at different locations. For example, subscriber data base 21 may reside in at least one first server, and mobile ad server 25 may reside in a second server at a location different from a location of the subscriber data base server. And of course functionalities operated by a MOBAD-Com in accordance with an embodiment of the invention may be cloud based and executed in part or in whole by various servers connected by the internet.

Subscriber data base 21 stores profiles of subscribers 32 that characterize, and may be used to infer, their consumer behavior. Optionally, a subscriber profile comprises a historical profile and an instant profile. A subscriber's historical profile may by way of example, include data as to the subscribers age, sex, income, hobbies, personal likes and dislikes, habitual movements in urban region 40, and a history of the subscriber's purchases. Data for the historical profile may for example be provided by subscriber 32 and/or be gathered by MOBAD-Com 20 from a history of the subscriber's purchases and/or his or her online activities. A subscriber's instant profile comprises real time, current data, his or her consumer behavior and geographical location. Information acquired for the subscriber's instant profile, optionally together with historical profile data, may be used by MOBAD-Com 20 to infer the subscriber's impending consumer behavior.

For example, the instant profile of a subscriber 32 may comprise information that the subscriber is currently querying a search engine, such as BING or Google, for locations of athletic shoe stores and prices of shoe styles they carry. It may therefore generally be inferred with a high degree of reliability that subscriber 32 intends to buy athletic shoes in the near future. If the subscriber's geographical location as provided by his or her smart phone 30 indicates that the subscriber has just left a sport shoe store and there is no record of a purchase made in the store by the subscriber, it is reasonable to infer that the subscriber is currently attempting to purchase athletic shoes. If historical profile data stored in subscriber data base 21 indicates that the subscriber regularly buys sport shoes in a particular store, it is a good bet that he or she will shortly appear in the store to buy shoes.

In an embodiment of the invention, a subscriber 32 to MOBAD-Com 20 is provided with a MOBAD-Com app (application software) that facilitates interfacing the subscriber smart phone 30 with the various services and functionalities provided by the MOBAD-Com. The app, which may voluntarily be activated and deactivated by the subscriber, when activated may enable the subscriber's smart phone 30 to receive mobile ads from the MOBAD-Com, and may operate to periodically poll the subscriber's smart phone to update MOBAD-Com as to the geographical location of the subscriber. The smart phone may determine its physical location using any of various location technologies such as by way of example, those employed by global navigation satellite systems, such as the global positioning satellite (GPS) system, mobile telephone networks, and/or Wi-Fi. In FIG. 1 smart phones 30 are schematically shown communicating with satellites 52 of a global navigation satellite system and/or base station antennas 50 of a mobile phone network, optionally to determine their physical locations. The MOBAD-Com app may also monitor Internet activity of the subscriber to enable MOBAD-Com to gather information for generating and updating the subscriber's historical and instant profiles.

Vendor data base 22 optionally stores data characterizing products and/or services offered by vendors using MOBAD-Com 20 and statistical data characterizing the histories of vendor mobile ads placed on smart phones 30 by MOBAD-Com. Statistical data stored in vendor data base 22 may comprise data that indicates how effective a vendor's mobile ads are in generating desired consumer responses and data characterizing how different segments of MOBAD-Com's subscribers relate to the vendor's products and/or services.

In an embodiment of the invention, consumer distribution engine 23 processes data in subscriber data base 21 to generate consumer distributions which provide distributions of a number of subscribers as a function of their location in urban region 40 and probability of purchasing products and/or services offered by vendors 42. In an embodiment of the invention consumer distribution engine 23 periodically generates consumer distributions for popular products and services offered by vendors 42, and alerts the vendors to relevant features of the distributions.

For example, assume a consumer distribution generated by consumer distribution engine 23 for high definition televisions (HD TVs) indicates a sudden surge in demand for HD TVs. MOBAD-Com 20 may alert vendors of the TVs among vendors 42 to the increased interest in their products and indicate to them, optionally by SMS messages, that a MOBAD-Com consumer distribution for HD TVs may be accessed via the MOBAD-Com website.

Optionally, the consumer distribution is provided to TV vendors that access the MOBAD-Com website in a graphical representation, optionally as a 3D column chart. Optionally the graphical representation is shown as an overlay on a geographical map of urban region 40, which shows locations of HD TV vendors in spatial relation to spatial features of the consumer distribution. A spatial feature of the distribution may, by way of example, be a geographical location of a peak in the population of subscribers 32 that are interested in HD TVs. Details and features of 3D column charts of consumer distributions, in accordance with an embodiment of the invention are shown in FIGS. 2A and 2B and are discussed below.

In response to the consumer distributions for HD TVs, vendors of the TVs among vendors 42 in urban region 40 may place bids for impressions of mobile ads promoting and incentivizing their HD TVs to be placed by MOBAD-Com 20 on smart phones 30 of subscribers polled to provide the consumer distribution. In accordance with an embodiment of the invention, a bid for impressions submitted by a given vendor 42 may be targeted to a particular segment of subscribers 32 polled to provide the HD TV consumer distribution. A segment may by way of example be a geographical segment that includes only those subscribers 32 located in a particular geographical portion, for example, a portion near the given vendor, of urban region 40. Optionally, a segment may relate to a portion of the subscribers that indicated a probability of purchasing a HD TV greater than a given probability. Upon receiving the bids, bidding engine 24 determines which of the bids are winning bids and ad server 25 sends the mobile ads of vendors submitting the winning bids to subscribers among subscribers 32 that were polled by MOBAD-Com 20 to determine the consumer distribution for HD TVs.

A bid for impressions of a mobile ad may also specify features of the impressions. For example, it may specify when impression of the mobile ad are to be sent to smart phones 30, and/or that an impression of a mobile ad occupy a desired given fraction of a smart phone 30 screen on which the mobile ad appears, and/or once it is placed, a duration of the ad on the screen.

It is noted that in the above discussion MOBAD-Com 20 initiated a bidding session by alerting vendors 42 in urban region 40 to a heightened interest in a product (in the above scenario HD TVs) provided by the vendors. A bid may of course also be initiated by a vendor who determines that she is interested in undertaking an ad campaign for her products. Optionally, in making the bid the vendor accesses MODAD-Com's web site and requests that MOBAD-Com provide a consumer distribution for the products so that the bid can be configured responsive to current market intelligence.

In some embodiments of the invention, a vendor may configure a “standing bid”, which the vendor submits to MOBAD-Com 20. A standing bid lies dormant until predetermined conditions defined by the bid are satisfied. When the conditions are satisfied the bid “triggers” and is considered by bidding engine 24 as an active bid for impressions for placement of an mobile ad associated with the standing bid. The conditions associated with a standing bid may be a time of day, a date, or appearance of predetermined characteristics of market intelligence that MOBAD-Com 20 generates. For example, the standing bid may trigger subject to a population of subscribers 32 within a predetermined distance from the vendor's place of business exceeding a threshold number and also showing a probability greater than a predetermined probability for purchasing a product vended by the vendor.

FIGS. 2A and 2B respectively show 3D column charts 200 and 300 representing hypothetical consumer distributions for dining out in the early evening that MOBAD-Com 20 provides to restaurant vendors 44 and 46, in accordance with an embodiment of the invention. The restaurants are competing for the attention of subscribers 32 in urban region 40, in an exemplary scenario described below, which illustrates features of consumer distributions and their uses.

Restaurants 44 and 46 are assumed to be moderately upscale restaurants that cater to evening diners. Restaurant 44 is relatively close to theater 48, which has been staging a very popular late matinee show to large, sell-out audiences. Typically, a large portion of the audience goes out to evening dinner after the show and MOBAD-Com 20 sees a regular surge in queries for evening dining venues between about 18:00 and about 20:00 every day on days that the matinee is held. Both restaurants 44 and 46 are anxious to attract potential diners from the theater audience and daily log onto the MOBAD-Com web site to request consumer distributions for dining out between 18:00 and 20:00 and bid for impressions. 3D column charts 200 and 300 represent consumer distributions for dining out that managers of restaurants 44 and 46 respectively access on a same early evening.

3D column chart 200 comprises columns 202 that represent features measured along axes 210, 220, and 230 of the chart. Height of a column 202 represents a number of subscribers 32 of MOBAD-Com 20. The height is measured along axis 210, which is graduated in numbers of subscribers.

Location of a column 202 relative to axis 220 indicates how far subscribers 32 represented by the column are from restaurant 44. (FIG. 1). Axis 220 is graduated in hundreds of meters from restaurant 44 shown adjacent witness lines 222 along the axis. For a column 202 located relative to axis 220 between two adjacent witness lines 222, the subscribers represented by the column are located at distances from restaurant 44 in a range of distances demarcated by the distances labeling the two witness lines.

Location of a column 202 relative to axis 230 gives a probability for dining out that characterizes subscribers 32 represented by the column. Probability of dining out is measured by a purchase probability index shown along axis 230. The index is an integer index having values between 1 and 5 shown between witness lines 232 along axis 230. Lowest and highest probabilities of dining out are respectively assigned probability of purchase indices of 1 and 5. Subscribers 32 represented by a given column 202 located relative to axis 230 between two witness lines 232 are characterized by consumer distribution engine 23 (FIG. 1) as having a probability of dining out indicated by the index shown between the witness lines.

By way of illustrative example, height of a peak column 202 individualized by a label 204, represents a number of subscribers 32 having a relatively high probability of purchase index 4 that are located at a maximum distance of about 100 m meters from restaurant 44. The population of subscribers 32 represented by peak column 204 is located in a portion of urban region 40 that includes a location of theater 48 (FIG. 1), and with a high degree of reliability includes the theater going crowd that went to the matinee showing given at the theater. The manager of restaurant 44 therefore submits a bid to MOBAD-Com 20 for impressions of mobile ads promoting restaurant 44 to be sent to subscribers represented by peak column 204 during a period of two hours beginning at a time about fifteen minutes after the matinee ends.

3D column chart 300 shown in FIG. 2B accessed by restaurant 46 has same axes as 3D column chart 200 and comprises columns 302. Whereas, the data graphed in 3D column charts 200 and 300 are the same, they appear different because the data represented by 3D column chart 300 is shown dependent on distance from restaurant 46 rather than distance from restaurant 44. For example, peak column 204 in 3D column chart 200 which represents a population comprising theater going subscribers of MOBAD-Com 20 corresponds to a peak column 304 in 3D column chart 300. Whereas peak column 204 appears between 0 m and 100 m from restaurant 44 in 3D column chart 200, peak column 304 representing the same subscribers of MOBAD-Com 20 that are represented by peak column 204 appears between 400 m and 500 m distant from restaurant 46 in 3D column chart 300.

The manager of restaurant 46, knowing that he is farther from the theater dining crowd represented by peak columns 204 and 304 than restaurant 44, submits a high bid for impressions of a full screen mobile ad promoting restaurant 46, on smart phones 30 of the subscribers represented by peak column 304. The bid requires that the full screen mobile be placed during the first half hour immediately after the matinee show at theater 48 lets out. The ad, in addition to capturing all of the subscriber smart phone screens on which it appears, includes an offer to pay cab fare from theater 48 to restaurant 46 for couples responding to the ad that come to dine at restaurant 46 within a half hour of a time at which the matinee show at theater 48 lets out.

Bids from restaurants 44 and 46 are processed by bidding engine 24 (FIG. 1) and the bid from restaurant 46 wins preferred placement of impressions over the bid for impressions submitted by restaurant 44. A number of full screen mobile ad impressions bid for by restaurant 46 appear on the smart phones of the theater going crowd before the impressions of the mobile ad bid for by restaurant 44 are placed on their smart phones. Restaurant 46 captures a large portion of the theater going dinner crowd at the expense of restaurant 44.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to person's of the art. The scope of the invention is limited only by the claims.

1. A method of providing impressions of a mobile ad on a person's mobile device, the method comprising:
tracking locations of people each of whom is characterized by a personal profile and is operating a mobile device that provides data for determining the device's location;
processing the location data and profiles to provide a distribution of a number of the people who are potential consumers of a given service and/or product as a function of location and a probability of purchasing a given service or product;
receiving a bid responsive to the distribution from each of at least one vendor for impressions of a mobile ad promoting the vendor's provision of the service and/or product; and
generating impressions of a mobile ad of a vendor of the at least one vendor on the mobile device of a consumer of the potential consumers responsive to the bid and the distribution.

2. A method according to claim 1 and comprising providing the distribution to the at least one vendor of the service and/or product prior to receiving the bid.

3. A method according to claim 1 wherein providing the distribution comprises providing a visual representation of the distribution.

4. A method according to claim 3 wherein providing the visual distribution comprises providing the distribution as an overlay of a visual representation of a spatial distribution of the vendors.

5. A method according to claim 1 wherein the bid is for an impression of a mobile ad on mobile devices of consumers located within a given distance from the vendor.

6. A method according to claim 1 wherein the bid is for placement of the impression on mobile devices of people located in a geographical region having a particular character.

7. A system comprising at least one computer server programmed having a computer instruction set configured to execute a method according to claim 1.
